(19) United States
(12) Patent Application Publication
(10) Pub. No.: US 2026/0042619 A1
(43) Pub. Date: Feb. 12, 2026

(54) STOCK RETRIEVAL SYSTEM AND METHOD

(71) Applicant: Ocado Innovation Limited, Hatfield (GB)

(72) Inventors: Lars Sverker Ture LINDBO, Stockholm (SE); Andrew INGRAM-TEDD, Hatfield (GB); Pawel KAROLINCZAK, Wroclaw (PL); Benjamin Arthur Portnoy NOAR, Hatfield (GB)

(21) Appl. No.: 19/363,399

(22) Filed: Oct. 20, 2025

Related U.S. Application Data
(63) Continuation of application No. PCT/EP2024/060917, filed on Apr. 22, 2024.

(30) Foreign Application Priority Data
Apr. 21, 2023 (GB) 2305908.2

(51) Int. Cl. B65G 47/90; B65B 35/30; B65G 47/94

(52) U.S. Cl. CPC B65G 47/90; B65B 35/30; B65G 47/94

(57) ABSTRACT

A stock retrieval system is provided, including: i) a storage container for containing stock; ii) a base plate configured to support stock and to be housed within the storage container, the base plate being vertically movable relative to a bottom of the storage container; and iii) a drive mechanism configured to move the base plate relative to the bottom of the storage container from a lowered position, in which the base plate is at a level below a top of at least one side wall of the storage container, to a raised position, in which the base plate is substantially at or above the same vertical level as the top of the at least one side wall of the storage container, wherein the drive mechanism includes at least one supporting rod comprising an upper end configured to engage with the underside of the base plate.

### TECHNICAL FIELD

The present disclosure relates to a stock retrieval system, for example for use in an automated warehouse or storage system, and to a method of using said stock retrieval system.

### BACKGROUND

When customers order goods for home delivery, it is an important part of the customer experience that the good should arrive undamaged and neatly packed. This can be a particular problem for clothing, which can very easily become crumpled during transit if not neatly folded and carefully packaged. The aim of the present disclosure is to provide a means of retrieving stock from a storage container in a manner that is fast, efficient, and does not cause any damage or disarray to the stock.

The stock retrieval system as described herein can be used as part of a larger storage and retrieval system, for example a cubic automated storage and retrieval system as described in WO2015/185628A.

### SUMMARY

In one aspect, the disclosure provides a stock retrieval system comprising:
i) a storage container for containing stock;
ii) a base plate configured to support stock and to be housed within the storage container, the base plate being vertically movable relative to a bottom of the storage container;
iii) a drive mechanism configured to move the base plate relative to the bottom of the storage container from a lowered position, in which the base plate is at a level below a top of at least one side wall of the storage container, to a raised position, in which the base plate is substantially at or above the same vertical level as the top of at least one side wall of the storage container,
wherein the drive mechanism comprises at least one supporting rod comprising an upper end configured to engage with the underside of the base plate.

This arrangement of supporting rods provides a simple and convenient way of moving the base plate from the lowered position to the raised position, and does not require the storage container itself to have any complex or moving parts.

The storage container may comprise a bottom wall comprising at least one opening, and the at least one supporting rod may be configured to protrude through the at least one opening. In other examples, the storage container could be open at the bottom, with a retaining lip and/or retaining protrusions to support a base plate inside the storage container. The storage container may have a box-like structure with four side walls and a bottom wall. As a further alternative, the storage container may be tapered such that the base plate is held in place at the bottom of the container by way of a friction or interference fit.

The bottom wall may comprise a plurality of openings, and the drive mechanism may comprise a plurality of supporting rods configured to protrude through the plurality of openings, each of the plurality of supporting rods comprising an upper end configured to engage with the underside of the base plate.

The base plate may be a flat plate in a plane. The base plate may be square or rectangular in shape. The base plate may comprise at least one side wall substantially lower in height than the at least one side wall of the storage container. The base plate may be a tray with side walls or a lip on all edges of the base plate. The advantage of the base plate being a flat plate or a tray with a lip or short side walls is that it easier to add stock onto the base plate or remove stock from the base plate, than to put stock into or remove stock from a container with higher side walls.

Advantageously, stock supported on the base plate is above the level of the top of the at least one side wall when the base plate is in the raised position, so the stock is easily accessible from the sides without the side walls of the storage container being an obstruction. This easy accessibility facilitates the fast retrieval of the stock from the storage container. Stock can be retrieved either manually, e.g. by a human worker lifting one or more stock items from the portion of the stock above the top of the at least one side wall, or by automated retrieval means, as will be described later. Fast retrieval enables automated systems to run quickly and efficiently with a high level of throughput. Convenient retrieval also has the advantage that the stock items are less likely to be damaged or disarrayed during the retrieval process. The raised position can be at the same vertical level as the top of the at least one side wall, or at a higher vertical level; in either case, the entirety of the stock supported on the base plate is accessible from the sides without the side walls of the storage container obstructing.

The stock retrieval system may further comprise a control system configured to control the drive mechanism to move the base plate between the raised position and the lowered position. The control system for the stock retrieval system can either be separate, or integrated into a control system for a larger storage system.

The control system may be further configured to control the drive mechanism to move the base plate from the lowered position to at least one intermediate position at a vertical level between the lowered position and the raised position.

An advantage of intermediate positions is that the portion of the stock that is vertically above the top of the at least one side wall can be varied, so that the stock retrieval system can conveniently handle different sizes and quantities of stock. For example, if the entire stock is required to be removed from the storage container, the raised position is more convenient for retrieval because the entire stock is above the level of the top of the at least one side wall. Conversely, if only one stock item or a small portion of the number of stock items are required, an intermediate position in which the base plate is lower than the vertical level of the top of the at least one side wall so that only the required stock items are above this level may be more convenient.

In other words, as well as a single raised position in which the base plate is at or above the vertical level of the top of the at least one side wall, the base plate can occupy one or more intermediate positions having different separations of the base plate relative to the bottom wall of the storage container, and the control system may be further configured to selectively move the base plate from the lowered position to one of the one or more intermediate positions such that the portion of the stock at a level vertically above the top of the at least one side wall is varied.

The drive mechanism may be configured to move the at least one supporting rod vertically upwards to lift the base plate within the storage container from the lowered position to the raised position. This arrangement has the advantage that the base plate and stock are lifted to a higher vertical level, which may be more convenient for retrieval.

The drive mechanism may be configured to be move the storage container vertically downwards relative to the base plate. This arrangement has the advantage that the at least one supporting rod does not have to lift the entire weight of the stock on the base plate, so the drive mechanism can be lighter and cheaper since the drive mechanism does not have to be capable of providing enough force to lift a heavy weight.

The stock retrieval system may further comprise a container conveying means configured to convey the storage container to a retrieval position, wherein the plurality of supporting rods are located below the retrieval position and configured to protrude through the plurality of openings in the bottom wall when the storage container is in the retrieval position. The container conveying means can be a conveyor, a robot arm, one or more vehicles, or any other suitable means that can transport a storage container. An advantage of this arrangement is that the container conveying means can bring storage containers from another part of a larger storage system or facility of which the stock retrieval system forms part. Different aspects of the larger storage system can be linked together in order to automate processes and increase throughput of the storage system. In addition, the container conveying means can also remove a storage container once the required stock has been retrieved, in order to clear space so that the stock retrieval system is ready for another storage container containing stock for retrieval.

In examples where the container conveying means is a container conveyor, the container conveyor may comprise rollers and the supporting rods may be configured to protrude between the rollers of the container conveyor. An advantage of this arrangement is effective use of space, since the drive mechanism can be located underneath the container conveyor in otherwise dead space. The spaces between the rollers of the container conveyor permit the supporting rods to perform their function without interfering with the operation of the container conveyor.

The drive mechanism may be contained within the storage container. This arrangement has the advantage that the drive mechanism does not take up additional space in the larger storage system, and the retrieval process can take place in any part of the storage system where the storage containers are located, without the need to install other equipment.

The drive mechanism may comprise one or more linear actuators. The one or more linear actuators may comprise hydraulic pistons and/or a rack and pinion mechanism and/or one or more electric motors. Any appropriate drive mechanism or combination of mechanisms that performs the function of moving the base plate between the lowered position and the raised position can be used.

The stock retrieval system may further comprise transfer means configured to remove at least one item of stock from the base plate, when the base plate is in the raised position. An advantage of the transfer means is that it provides a convenient way of retrieving stock, resulting in a faster and more efficient stock retrieval system.

The stock retrieval system may further comprise a stock surface. In examples where the stock retrieval system comprises a transfer means, the transfer means can remove at least one stock item and place the at least one stock item on the stock surface. In examples where a human worker retrieves the stock, the worker can place the at least one stock item on the stock surface.

The stock surface may be a stock conveying means configured to convey the at least one stock item away from the stock retrieval system. An advantage of a stock conveying means is that stock, once retrieved from the storage containers, can be conveyed away from the stock retrieval system to another part of the larger storage system, for example to a picking station or packing station. The stock conveying means keeps the stock moving, so that there is space available for stock items to be retrieved from the next storage container and placed on the stock conveying means, without the need to wait until the stock retrieved from the previous container has been processed. The stock conveying means can be a stock conveyor, a robot arm, or any other suitable means that can transport stock.

The transfer means may comprise a robot arm with an end effector comprising one or more horizontal lifting plates, such that in a closed position the one or more horizontal lifting plates moveable between a closed position in which the one or more horizontal lifting plates support the at least one item of stock from below and an open position in which the one or more horizontal lifting plates are disengaged with the at least one item of stock. The robot arm provides flexibility in movement, i.e. the stock can be retrieved from a storage container within reach of the robot arm without the need for the storage container to be in precisely the correct location. Another advantage of this arrangement is that the lifting plates can slide underneath a stock item and support the stock item securely, reducing the risk that the stock item will be dropped and potentially damaged. Also, since the lifting plates support the stock items from below rather than exerting pressure on the sides of the stock items, there is a reduced risk that the stock items will be crushed or damaged during transfer.

The transfer means may comprise a robot arm ending in a grabber device being configured to move between a closed position and an open position, such that in the closed position the grabber device is configured to engage with the at least one stock item, and in the open position the grabber device is configured to release the at least one stock item. The grabber device provides a convenient means of transferring stock.

The transfer means may comprise a tilting mechanism configured to tilt the base plate at the raised position to an inclined position to allow the at least one item of stock to be removed by sliding off the base plate. An advantage of this arrangement is that one part (the base plate) is used to fulfil two different functions; not only is the base plate moved into the raised position so that the stock is accessible, but also the base plate is tilted to remove the stock. Advantageously the double function of the base plate means that the stock retrieval system is simpler and has fewer parts, and is thus cheaper to manufacture and easier to build and assemble.

The at least one supporting rod may comprise a plurality of supporting rods and the tilting mechanism may be configured to move a first set of the plurality of supporting rods relative to a second set of the plurality of supporting rods such that the upper ends of the second set of supporting rods are at a higher vertical level than the upper ends of the first set of supporting rods. A set of supporting rods may comprise one supporting rod or a plurality of supporting rods. This arrangement provides a simple means of moving the base plate between the raised position (which may be horizontal) and the inclined position, again without requiring any extra parts. The supporting rods provide two functions: lifting the base plate into the raised position, and tilting the base plate into the inclined position. The transfer means may comprise a pushing device configured to move in a direction parallel to the base plate so as to remove the at least one stock item from the storage container by pushing the at least one item of stock off the base plate. This arrangement is a simple and effective way of facilitating the transfer of stock.

The transfer means may comprise any combination of the above described examples, for example the transfer means may comprise a robot arm and/or a pushing device and/or a tilting mechanism.

The upper end of one or more of the at least one supporting rod may comprise a wheel to facilitate movement of the base plate in order to insert/remove the base plate into/from the container when the base plate is in the raised position. Advantageously, this arrangement provides an easy way to separate the base plate from the storage container, or to combine the base plate with the container. The base plate may be loaded with stock in a different part of a larger storage and retrieval system, then combined with a storage container, then stored in a different part of the system or dispatched.

The stock retrieval system may further comprise a container conveying means configured to move the storage container in a first direction into a retrieval position in which the base plate can be inserted into or removed from the container, and a base plate conveying means configured to convey a base plate to or from the retrieval position in a second direction, wherein the second direction is perpendicular to the first direction. The container conveying means may be a container conveyor. The base plate conveying means may be a base plate conveyor. Advantageously, this arrangement makes efficient use of space and allows base plates (with to without stock) to be loaded into/removed from storage containers at the position where the two conveyor lines intersect.

The upper end of one or more of the at least one supporting rod and/or the underside of the base plate may comprise an engagement feature configured to engage the upper end of the supporting rod with the underside of the base plate. This helps to ensure that the base plate can accurately be moved into the raised position or the lowered position. For example, in the lowered position the base plate lies flat on top of the bottom wall of the storage container, and in the raised position the base plate is level and at the correct height to enable stock to be placed on or removed from the base plate, or to enable the base plate to be removed from the storage container.

The engagement feature may comprise one of a high friction surface, an electroadhesive surface, an electromagnetic pad, and a permanent magnetic pad.

In examples where the storage container comprises a bottom wall, the stock retrieval system may further comprise seals surrounding the openings in the bottom wall of the storage container and/or a seal surrounding the edge of the base plate and/or a space between the base plate and the bottom wall, optionally wherein the space comprises a moisture sensor. These features help to contain any liquid spills within the storage container, and in some cases also detect the presence of liquid within the container.

The inside of the at least one side wall of the storage container may comprise a vertical rib and the base plate may comprise a corresponding recess, such that the vertical rib and the recess co-operate to guide the vertical movement of the base plate between the lowered position and the raised position. The inside of the at least one side wall of the storage container may comprise a vertical groove and the base plate may comprise a corresponding protrusion, such that the vertical groove and the protrusion co-operate to guide the vertical movement of the base plate between the lowered position and the raised position. Advantageously, these arrangements help to keep the base plate aligned inside the storage container, and to ensure smooth motion of the base plate between the raised and lowered positions.

In another aspect, the disclosure provides a method of retrieving stock using the stock retrieval system as described above, wherein the storage container comprises one or more items of stock on the base plate, the method comprising the steps of:
i) moving the base plate from the lowered position to the raised position or an intermediate position between the lowered position and the raised position using the drive mechanism such that at least one item of stock on the base plate is at a level vertically above the top of the at least one side wall of the storage container;
ii) removing the at least one item of stock from the base plate.

In examples where the stock retrieval system further comprises a stock conveying means, the method may further comprise the step of:
iii) transferring the at least one item of stock onto the stock conveying means; and
v) transporting the at least one stock item away from the stock retrieval system using the stock conveying means.

In some examples, e.g. where the transfer mechanism is a tilting mechanism or a pushing mechanism, the steps of removing at least one stock item from the base plate and transferring the at least one item of stock onto the stock conveying means may be the same action.

In examples where the stock retrieval system comprises a container conveying means configured to move a storage container into a retrieval position, the method may further comprise the steps of:
before step i), moving the storage container to the retrieval position using the container conveying means;
after step ii), moving the base plate to the lowered position using the drive mechanism, moving the storage container away from the retrieval position using the container conveying means, and moving another storage container into the retrieval position using the container conveying means.

In some examples, the above method steps may be performed in the reverse order to place stock inside the storage container.

In another aspect, the disclosure provides a method of combining a base plate with a storage container using the stock retrieval system as described above, the method comprising the steps of:
i) moving the storage container into the retrieval position using the container conveying means;
ii) raising the at least one supporting rod;
iii) moving the base plate from the base plate conveying means to the raised position on top of the at least one supporting rod;
iv) lowering the base plate from the raised position to the lowered position inside the storage container;
v) removing the storage container and base plate from the retrieval position using the container conveying means.

This method can also be applied in the reverse direction to separate a base plate from a storage container. The disclosure provides a method of separating a base plate from a storage container using the stock retrieval system as defined above, the method comprising the steps of:
i) moving the storage container and base plate into the retrieval position using the container conveying means;
ii) raising the base plate into the raised position;
iii) moving the base plate from the raised position to the base plate conveying means;
iv) lowering the at least one supporting rod;
v) removing the storage container from the retrieval position using the container conveying means.

### BRIEF DESCRIPTION OF THE FIGURES

Further features and aspects of the present disclosure will be apparent from the following detailed description of illustrative embodiments made with reference to the drawings.

FIG. 1 schematically illustrates a storage container and stock for use in a stock retrieval system.

FIGS. 2A-2B schematically illustrate a stock retrieval system with the base plate in the lowered position (left) and raised position (right), where, in FIG. 2A, the supporting rods lift the base plate, and in FIG. 2B, the storage container drops down relative to the base plate.

FIGS. 3A-3C schematically illustrate a stock retrieval system with the base plate in the lowered position (FIG. 3A), an intermediate position (FIG. 3B), and the raised position (FIG. 3C).

FIG. 4 schematically illustrates a first embodiment of a stock retrieval system with transfer means comprising a robot arm with a grabber device.

FIG. 5 schematically illustrates the stock retrieval system of FIG. 3, with the grabber device in the closed position.

FIG. 6 schematically illustrates a cross-sectional view of the stock retrieval system of FIGS. 4 and 5.

FIG. 7 schematically illustrates a cross-sectional view of the same stock retrieval system as shown in FIGS. 4, 5, and 6.

FIG. 8 illustrates a second embodiment of a stock retrieval system where the transfer means is a tilting mechanism.

FIGS. 9A-9D schematically illustrate the transfer means provided by a tilting mechanism, with the base plate in lowered position (FIG. 9A), a raised position (FIG. 9B), an inclined position (FIG. 9C), and an inclined position with the stock transferred to the stock surface (FIG. 9D).

FIG. 10 illustrates another view of the stock retrieval system of FIG. 7.

FIG. 11 illustrates a further detail of the stock retrieval system of FIG. 7, with a roller between the base plate and the stock surface.

FIG. 12 illustrates a further detail of the stock retrieval system of FIG. 7, with guide wheels.

FIG. 13 illustrates a further detail of the stock retrieval system of FIG. 7, with guide channels for guiding the guide wheels.

FIG. 14 illustrates a cross-sectional view of the stock retrieval system of FIG. 7.

FIG. 15 illustrates a third embodiment of a stock retrieval system where the transfer means is a pushing device, with the pushing device in a retracted position.

FIG. 16 illustrates the stock retrieval system of FIG. 15 with the pushing device in a deployed position.

FIG. 17 illustrates the stock retrieval system of FIG. 15, showing the drive mechanism.

FIG. 18 is a flowchart schematically illustrating a method of stock retrieval, using the stock retrieval system as described above.

FIG. 19 illustrates another example of the stock retrieval machine with wheels on the supporting rods.

FIGS. 20A-20D schematically illustrate the stock retrieval machine of FIG. 19 in operation: a base plate being conveyed into the retrieval position (FIG. 20A); the base plate in the retrieval position (FIG. 20B); the base plate is lowered into the storage container (FIG. 20C); and the base plate in the lowered position (FIG. 20D).

FIGS. 21A and 21B illustrate two different examples of engagement features: pads at the upper ends of the supporting rods (FIG. 21A), and upper ends of the supporting rods are tapered (FIG. 21B).

FIGS. 22A and 22B schematically illustrate an example of a storage container, base plate, and supporting rods for containing liquid spills, in lowered position (FIG. 22A) and a raised position (FIG. 22B).

FIGS. 23A and 23B illustrate examples of alignment features on the base plate and storage container: vertical ribs and corresponding recesses (FIG. 23A), and vertical grooves and corresponding protrusions (FIG. 23B).

### DETAILED DESCRIPTION

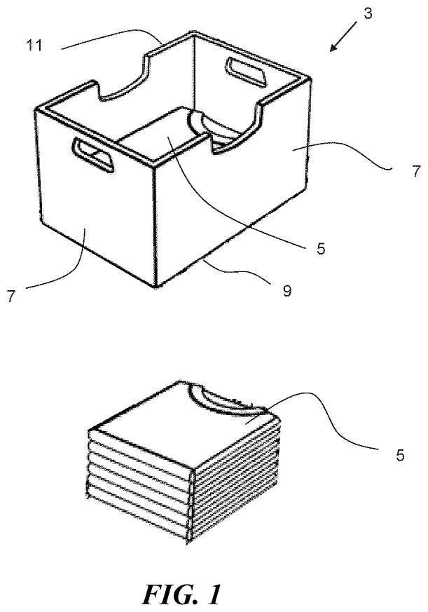

FIG. 1 schematically illustrates a storage container 3. The storage container 3 is an open box, with four side walls 7 and a bottom wall 9. The upper edge of the side walls 7 defines a rim 11. In the illustrated example, all four side walls 7 have a rim 11 at the same vertical height, and the rim 11 extends around the periphery of the storage container 3.

The storage container 3 contains stock 5. In the illustrated example the stock 5 is a pile of folded garments, but in other examples the stock 5 could be different kinds of goods. The stock 5 can be one item, or several items, for example a pile of folded garments stacked on top of one another. The stock 5 is contained within the storage container 3 and does not protrude above the level of the rim 11.

In order to facilitate convenient and fast retrieval of the stock 5 from the storage container 3, the stock must be raised up to a level where at least part of the stock is above the level of the rim 11. This is achieved by means of a base plate within the storage container 3, upon which the stock 5 is placed.

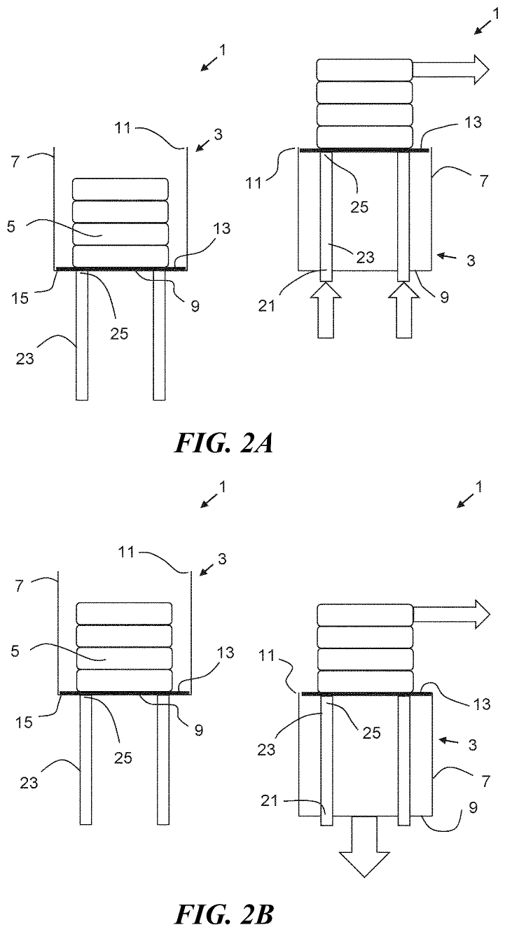

FIGS. 2A and 2B schematically illustrate how the stock in a stock retrieval system can be raised relative to the container so that at least part of the stock is above the level of the rim 11. In the following description, the words “raised position” and “lowered position” should be interpreted as describing the relative position of the base plate 13 and the storage container 3, irrespective of whether the base plate 13 or the storage container 3 has moved. In other words, “lowered position” refers to a position in which the base plate 13 is resting on top of the bottom wall 9 of the storage container 3, and all of the stock 5 in the storage container 3 is at a lower vertical level than the rim 11 of the storage container 3. “Raised position” refers to a position in which the base plate 13 is at the same vertical level or a higher vertical level than the rim 11 of the storage container. In the raised position, all of the stock 5 is above the level of the rim 11. In the illustrated example, in the raised position the base plate 13 is at the same vertical level as the rim 11. In other examples, the base plate in the raised position may be at a higher vertical level than the rim of the storage container.

FIG. 2A illustrates a stock retrieval system in the lowered position (left) and in the raised position (right). As in FIG. 1, the storage container 3 is an open box-like structure comprising a base wall 9 and side walls 7. In the lowered position, a base plate 13 is located within the storage container 3 and rests directly on top of the base wall 9. The base plate 13 is a flat plate with free edges 15. The free edges 15 of the base plate 13 are adjacent to the side walls 7 of the storage container 3. In the illustrated example (viewed from the side), the storage container 3 comprises four side walls 7, and the base plate 13 is a rectangular plate with four free edges 15. Each of the four free edges 15 is located adjacent to a respective one of the four side walls 7. The base plate 13 is supported by the upper ends 25 of supporting rods 23, which protrude through openings 21 in the bottom wall 9 of the storage container 3. The openings 21 are locating holes for ensuring that the supporting rods 23 move in the correct direction, e.g. vertically.

Although illustrated in FIGS. 2A and 2B as a flat plate with free edges, in other examples the base plate 13 can be a tray with a lip on one or more of the edges.

In the raised position (right), the supporting rods 23 have been raised upwards by a drive mechanism (not shown). The base plate 13 is raised from its original position, and spaced apart from the bottom wall 9 of the storage container. The base plate 13 has been lifted vertically upwards to the same vertical level as the rim 11 of the storage container. All of the stock 5 is above the level of the rim. The arrows on FIG. 2A (right) represent the direction of movement. In this example, the base plate 13 and the stock 5 have been lifted upwards (see vertical arrows) relative to the storage container 3, which remains in its original position. When the base plate 13 is in the raised position, the stock 5, which is now above the level of the rim 11, can more easily be retrieved in a horizontal direction (see horizontal arrow) because the side walls 7 of the storage container 3 are no longer an obstruction.

FIG. 2B illustrates an example where the storage container is moved vertically downwards relative to the base plate 13 and the stock 5, which remain in their original position. In the raised position (left) the example of FIG. 2B looks identical to the example of FIG. 2A, but in the lowered position (right) it is the storage container 3 that has moved, rather than the base plate 13 and stock 5. The arrows on FIG. 2B represent the direction of movement. In this example, the storage container 3 drops downwards (vertical arrow) relative to the base plate 13 and the stock 5. Again, when the base plate 13 is in the raised position the stock 5 is above the level of the rim 11 of the slide walls 7 of the storage container 3, which facilitates retrieval of stock items from the top of the pile in a horizontal direction (see horizontal arrow).

In some examples, in order to move from the lowered position to the raised position the storage container 3 can be lowered and the base plate 13 can be raised.

When the base plate 13 is in the raised position, the stock 5 is above the level of the rim 11 so can more easily be accessed. In some examples, one or more stock items can be accessed by a human worker (for example, garments lifted from the top of a stack of garments). In other examples, a transfer means is provided to transfer one or more stock items from the base plate 13 to a stock surface located adjacent or close to the storage container.

The stock retrieval system may be provided with a control system to control the drive mechanism. The control system can control the movement of the base plate and/or the storage container in order to move between the raised position and the lowered position.

The number of supporting rods can be varied. For example, a single supporting rod can be used, or a pair of supporting rods, or four supporting rods positioned to engage at or near the four corners of a square or rectangular base plate.

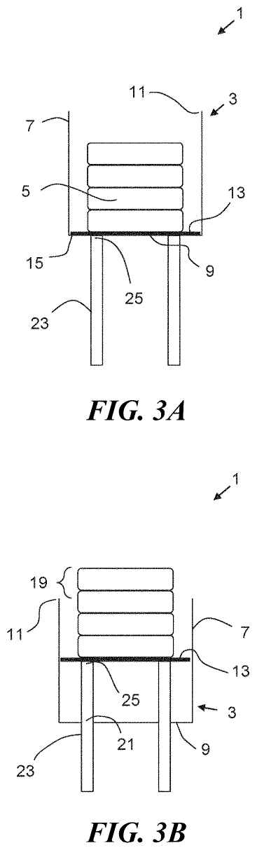

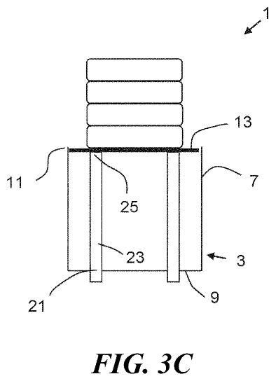

FIGS. 3A-3C schematically illustrate a stock retrieval system with the base plate in the lowered position (FIG. 3A), an intermediate position (FIG. 3B), and the raised position (FIG. 3C). The lowered position shown in FIG. 3A is described above with reference to FIG. 2A (left), and the raised position shown in FIG. 3C is described above with reference to FIG. 2A (right). When in the intermediate position, as shown in FIG. 3B, the base plate 13 is at a vertical level between the vertical level of the base plate 13 in the lowered position and the vertical level of the base plate 13 in the raised position. In the intermediate position a portion 19 of the stock 5 on the base plate protrudes above the vertical level of the rim 11 and some of the stock 5 is below the vertical level of the rim. The portion 19 of the stock above the vertical level of the rim is accessible from the side for retrieval. The intermediate position may be more convenient when retrieving one stock item or a small portion of the stock items from the storage container, rather than the whole stock.

Intermediate positions are also applicable in examples such as the example described in relation to FIG. 2B where the storage container is lowered by the drive mechanism rather than the base plate being raised. In that case, when in the intermediate position the base plate remains at the same vertical level, but the vertical level of the storage container in the intermediate position is in between the vertical level of the storage container in the lowered position and the vertical level of the storage container in the raised position.

Although only a single intermediate position is shown in the illustrated example, in other examples the base plate may have multiple intermediate positions at different vertical positions between the lowered position and the raised position.

### Robot Arm—First Embodiment of Transfer Means

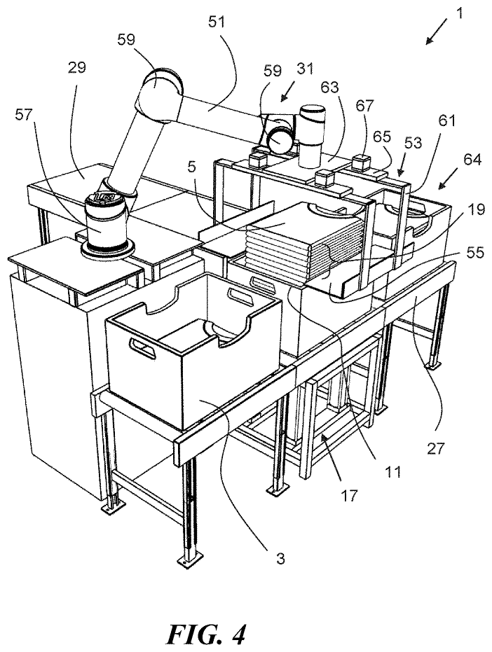

FIG. 4 schematically illustrates one example of a stock retrieval system 1 with transfer means 31. In this example the transfer means 31 comprises a robot arm 51 with a grabber device 64. The distal end of the robot arm 31 comprises a central hub 63 and a pair of jaws 53 configured to open and close in order to pick up stock items from the base plate 13, or from the portion 19 of the stock 5 above the level of the rim 11 of the storage container 3. Each of the jaws 53 comprises two frame members 61 attached to a horizontal plate 55. The frame members 61 of the jaws 53 are slidingly connected to the central hub 63 of the grabber device 64. The central hub 63 comprises four horizontally extending members 65. Each of the four frame members 61 is slidingly engaged with a respective one of the four horizontally extending members 65, such that the frame members 61 can slide inwards and outwards with respect to the central hub 63 in order to open and close the jaws 53. The movement of the frame members is actuated by actuators 67 located on each of the four horizontally extending members 65.

The robot arm 51 is mounted on a robot base 57, which enables the robot arm 51 to rotate through 360°. The robot arm comprises joints 59 (in this case an elbow joint and a wrist joint) to enable the jaws to move horizontally and vertically. A container conveyor 27 is located next to the robot arm, with storage containers 3 containing stock 5. A drive mechanism 17 is located below the container conveyor 27. A stock surface 29 is located next to the robot arm 51.

Although the example of FIG. 4 uses a container conveyor 27, in other examples different container conveying means can be used in place of the container conveyor 27. For example, the container conveying means can be a conveyor, a robot arm, one or more vehicles, or any other suitable means that can transport a storage container. Any appropriate container conveying means can be used in combination with any examples of the stock retrieval machine described herein.

In use, storage containers 3 containing stock 5 are conveyed along the container conveyor 27. When a target storage container 3 is within reach of the robot arm 51, for example at a pre-defined retrieval position above the drive mechanism 17, the drive mechanism is activated to lift the base plate (not visible in this figure) and the stock 5 into the raised position. When the base plate is in the raised position, either the whole stock 5 or a portion 19 of the stock 5 protrudes above the vertical level of the rim 11 of the storage container 3, and is therefore accessible from the sides. The robot arm 51 moves until the grabber device 64 is positioned above the storage container 3. The jaws 53 move into the open position; this is achieved by the frame members 61 sliding outwards with respect to the horizontally extending members 65. The robot arm lowers the grabber device 64 until the horizontal plates 55 are positioned either side of the stock 5 or the portion 19 of the stock 5 above the level of the rim 11 of the storage container 3 in the retrieval position. The actuators 67 then cause the frame members 61 to retract, sliding inwards with respect to the horizontally extending members 65, moving the jaws 53 form the open position to the closed position. As the jaws 53 close, the horizontal plates 55 slide underneath stock items in order to lift the stock items from the top of the pile of stock items in the storage container 3.

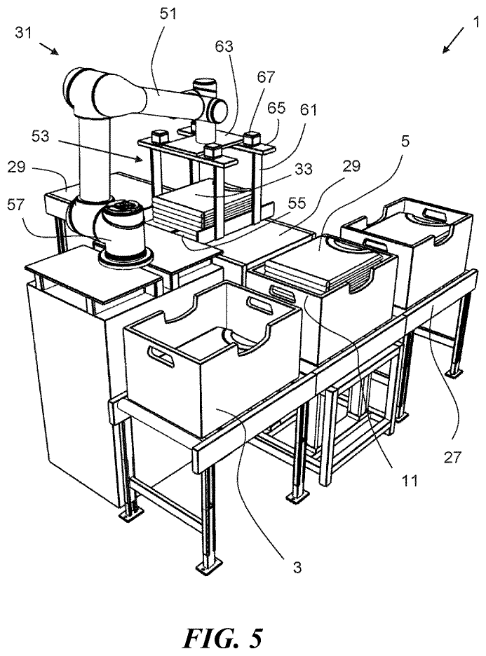

FIG. 5 schematically illustrates the stock retrieval system of FIG. 4, with the jaws 53 in the closed position. The two horizontal plates 55 have moved closer together to close the gap between them, supporting the stock items 33 on top of the two horizontal plates 55. The robot arm 51 can then lift the grabber device 64 and the stock items 33, and place the stock items 33 on the stock surface 29.

As seen in the illustrated example, the robot base 57 can rotate in order to move the grabber device 64 away from the storage container 3 and position the grabber device 64 and stock items 33 above the stock surface 29.

Once positioned above the stock surface 29, the robot arm lowers the stock items 33 and grabber device 64 until the horizontal plates 55 are resting on or slightly above the stock surface 29. The jaws 53 then move from the closed position to the open position, the horizontal plates 55 slide out from underneath the stock items 33, and the stock items 33 are deposited on the stock surface 29.

The output surface 29 can be a table, for example at an order picking station and/or a packing station. In other examples, the stock surface 29 can be a stock conveying means that conveys the stock items 33 away from the stock retrieval machine, for example to an order picking station and/or a packing station in another part of the warehouse or storage and retrieval system. For example, the stock conveying means can be a conveyor, a robot arm, one or more vehicles, or any other suitable means that can transport stock. Any appropriate stock conveying means can be used in combination with any examples of the stock retrieval machine described herein.

In the illustrated example, the stock surface 29 extends perpendicularly to the container conveyor 27. This arrangement is an effective use of space, particularly in examples where the stock surface 29 is a stock conveyor configured to convey the stock away from the stock retrieval system in a direction perpendicular to the direction of the container conveyor. In other examples, other arrangements of container conveyors and stock surfaces or stock conveying means are possible.

After retrieving the stock items 33 from the storage container 3, the base plate 13 can be moved back to the lowered position, then the storage container 3 can be transported away from the retrieval position, and another storage container 3 can be transported to the retrieval position ready for the robot arm 51 and grabber device 64 to retrieve stock items from another container 3.

In the illustrated example, the grabber device 64 comprises a two opposing jaws 53. In other examples, other configurations of grabber devices can be used. For example, the grabber device can comprise claws or other gripping elements rather than jaws, and more than two gripping elements can be provided rather than a pair. In another example, jaws or claws or other gripping elements can engage with the stock items 33 directly and hold the stock items by exerting pressure on either side or on more than one side of the stock items, rather than horizontal plates sliding underneath the stock items.

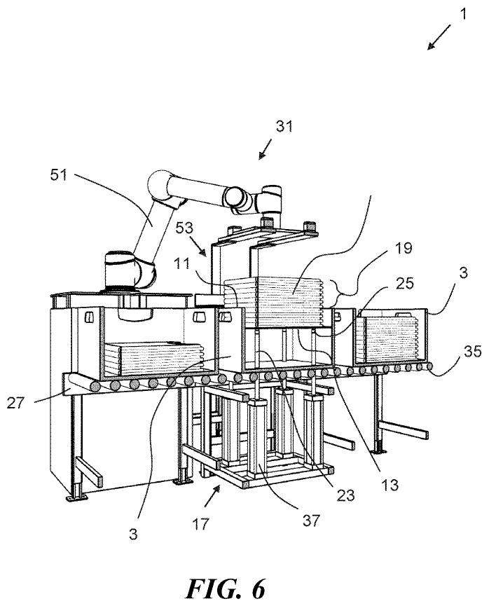

FIG. 6 is a cross sectional view of the stock retrieval system of FIGS. 4 and 5.

The drive mechanism 17 can be seen underneath the storage container 3 in the retrieval position. The drive mechanism 17 comprises four supporting rods 23, each with a respective piston 37 configured to drive the supporting rods 23 upwards and downwards. The upper ends of the supporting rods 23 engage with the underside of the base plate 13, and lift up the base plate 13 and the stock 5 resting on the base plate 13. In the illustrated example, the four supporting rods are arranged such that one supporting rod is positioned near each of the four corners of the base plate 13, but in other examples, different numbers and arrangements of supporting rods 23 are possible. The drive mechanism 17 can be a hydraulic mechanism, linear actuators, a rack-and-pinion mechanism, or any other suitable mechanism or combination of mechanisms.

The container conveyor 27 (shown with the front part removed for ease of illustration) comprises rollers 35. The rollers rotate in order to transfer storage containers 3 along the container conveyor 27. The supporting rods 23 are arranged to protrude through the spaces in between the rollers 35. In other examples, conveyors of different types can be used. In some examples, the container conveyor 27 can be provided with a stop (not shown) to make the storage container 3 stop in the retrieval position, i.e. in the correct position to be aligned with the supporting rods 23.

As can be seen in FIG. 6, in the intermediate position the base plate 13 is still below the vertical level of the rim 11 of the storage container 3. Although a portion 19 of the stock 5 protrudes above the level of the rim 11, some of the stock 5 is still below the level of the rim. The height of the horizontal plates 55 of the grabber device 64 can be varied by movement of the robot arm 51. Therefore it is possible to vary how much of the stock 5 is lifted by the grabber device, i.e. how many stock items 33 are picked up and transferred from the storage container to the stock surface. Advantageously, this allows the required number of stock items 33 to be retrieved. For example, if a customer order is for one stock item, the grabber device can retrieve one stock item 33 and leave the remainder of the stock 5 in the storage container 3.

In FIG. 6 the base plate 13 is in the intermediate position. The base plate 13 is spaced apart from the bottom wall 9 of the storage container 3. A portion 19 of the stock 5 is lifted above the vertical level of the rim 11 of the side wall of the storage container 3 in the retrieval position, and therefore this portion 19 is accessible from the sides. It can be seen from the figure that the jaws 53 (of which only one is illustrated) are in the open position, ready to close and lift up stock items from the pile of stock items in the storage container 3.

In some examples, the drive mechanism and/or the robot arm can be provided with sensors (not shown) to ensure that the horizontal lifting plates engage at the correct vertical level, for example to slide between items of stock in a stack of items. The sensors can be, for example, motion sensors, proximity sensors, or visual sensors. The sensors can be used to determine how far upwards the supporting rods 23 should lift the base plate 13, and/or the required position for the grabber device before the horizontal lifting plates should move to their closed position.

As described above, the stock retrieval system can be provided with a control system configured to control the drive mechanism, for example by controlling the movement of the base plate in order to move between the raised position and the lowered position. In some examples there may be intermediate positions in addition to the raised position, i.e. the control system is configured to selectively raise the base plate to different positions relative to the bottom wall of the storage container, depending on the number of stock items and the dimensions of individual stock items in the storage container. Different positions will lift a different proportion of the stock above the level of the rim of the storage container. For example, the raised position may be appropriate if all or most of the stock is to be transferred, and an intermediate position may be more convenient if only one or a small proportion of the total number of stock items are to be transferred, leaving some stock items in the container. In some examples there may be further positions at a vertical level above the raised position.

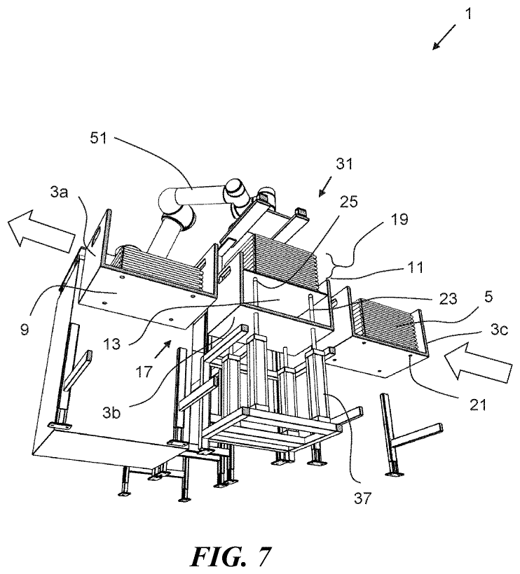

FIG. 7 is a cross sectional view of the same stock retrieval system as shown in FIGS. 4, 5, and 6, viewed from below in order to show the drive mechanism in more detail. In the figure, one of the pair of jaws 53, the container conveyor 27, and a side wall of each of the storage containers 3 have been removed for ease of illustration. Three storage containers 3a, 3b, 3c can be seen. The openings 21 in the bottom wall 9 of the storage containers 3 can easily be seen. The supporting rods 23 can be seen passing through the openings 21 in the bottom wall 9 of the storage container 3b in the retrieval position, with the upper ends 25 of the supporting rods 21 engaging with the underside of the base plate 13. The underside of the base plate 13 may comprise engagement features to locate the supporting rods 23, for example recesses shaped to receive the upper ends 25 of the supporting rods 23.

The direction of movement of the storage containers 3 along the container conveyor (not shown) is indicated by arrows on FIG. 7. The storage container labelled 3a has already had some of the stock 5 removed. The storage container labelled 3b is currently in the retrieval position, ready for the grabber device 64 to retrieve some stock items. The storage container labelled 3c has a higher level of stock 5, and is waiting to move into the retrieval position once the stock items have been retrieved from the previous storage container 3b in the line of storage containers 3.

The first embodiment of the transfer means 31 can also operate in the reverse direction. For example, the grabber device can retrieve one or more stock items 5 from the stock surface 29, the robot arm 51 can move the grabber device 64 over a storage container 3, and the grabber device 64 can place the stock items 5 back in the storage container 3 (when the base plate is in the raised position or the intermediate position). This functionality could be useful for example when processing returns from customers. Effectively the stock retrieval system is working in reverse, i.e. returning stock items to the storage system rather than retrieving stock items from the storage system.

The drive mechanism as illustrated and described above may also apply to other embodiments of the stock retrieval system, e.g. the embodiments described below.

### Tilting Mechanism—Second Embodiment of Transfer Means

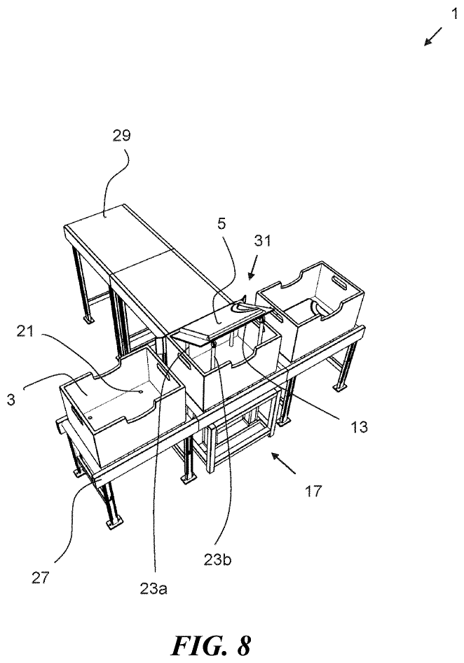

FIG. 8 illustrates a stock retrieval system 1 with a different transfer means 31. In this case the transfer means 31 is a tilting mechanism that enables the base plate 13 to tilt in order to transfer the stock 5 from the storage container to the stock surface 29. The supporting rods 23 comprise two sets of supporting rods, a first set 23a and a second set 23b. The first set of supporting rods 23a are positioned on the side of the base plate 13 closest to the stock surface 29, and the second set of supporting rods 23a are positioned on the side of the base plate 13 farthest from the stock surface 29. In the illustrated example, the first set of supporting rods 23a and the second set of supporting rods 23b each consist of two supporting rods, making a total of four supporting rods 23. Four rods are convenient for square or rectangular shaped storage containers 3, because one supporting rod 23 can engage with each of the four corners of the square or rectangular shaped base plate 13. In other examples, the first and second supporting rods 23a, 23b can comprise different numbers of rods, and/or the storage container 3 and the base plate 13 can be different shapes. For example, the first set of supporting rods can comprise one supporting rod, and the second set of supporting rods can comprise one supporting rod.

In use, the container conveyor 27 brings a storage container 3 to the retrieval position. The supporting rods 23a, 23b move upwards, protruding through the openings 21 in the bottom wall 9 of the storage container 3, and engaging with the base plate 13. The supporting rods 23a, 23b continue moving upwards, lifting the base plate 13 to the raised position. When in the raised position, the base plate 13 is lifted by the supporting rods 23a, 23b up to the rim 11 of the side walls of the storage container 3, so that the base plate 13 is flat. The first set of supporting rods 23a stop lifting when the base plate 13 reaches the same vertical level as the rim 11. The second set of supporting rods 23b continue to lift the base plate 13 above the level of the rim 11, so that the base plate 13 is in a tilted position, in which the base plate 13 is tilted towards the stock surface 29. The inclination of the base plate 13 causes the stock 5 to slide from the base plate 13 onto the stock surface 29.

Unlike the robot arm and grabber device transfer means in the previous example, all of the stock 5 in a given storage container 3 is transferred by the transfer means in this example. When the base plate 13 is in the raised position, the whole of the stock 5 is above the vertical level of the rim 11. In the illustrated example the stock 5 comprises one item, but in other examples the stock 5 can comprise several items, for example a stack of folded garments or a stack of other products.

In the example of FIG. 8, the transfer means 31 is integrated with the drive mechanism 17; the supporting rods 23 perform two functions by lifting the base plate 13 into the raised position, and by further moving the base plate 13 into the tilted position, in which the base plate 13 is tilted to transfer the stock 5 onto the stock surface 29. This results in a simpler design with fewer parts.

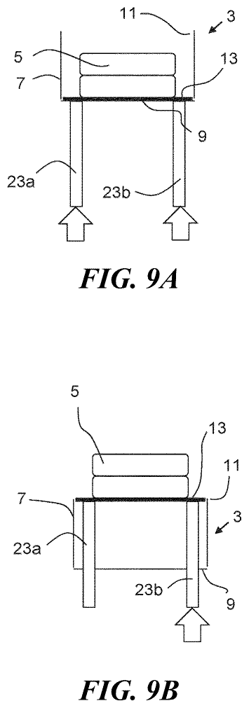

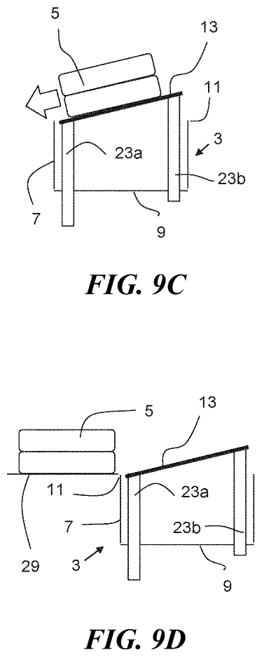

FIGS. 9A-9D schematically illustrate the transfer means 31 where the transfer means is a tilting mechanism. The arrows represent the direction of movement. In FIG. 9A, the base plate 13 is in the lowered position, resting on top of the bottom wall 9 of the storage container 3. In FIG. 9B, the base plate 13 is in the raised position, at the same vertical level as the rim 11 of the side walls 7 of the storage container 3. The first and second sets of supporting rods 23a, 23b have lifted the base plate 13 through the same vertical distance. In FIG. 9C, the base plate 13 is in the inclined position. The first set of supporting rods 23a remains in the same position as in FIG. 9B, and the second set of supporting rods 23b has moved farther up, lifting up one end of the base plate 13 so that the base plate 13 is inclined at an angle to the horizontal. In FIG. 9D, the stock 5 has slid from the inclined base plate 13 onto the adjacent stock surface 29.

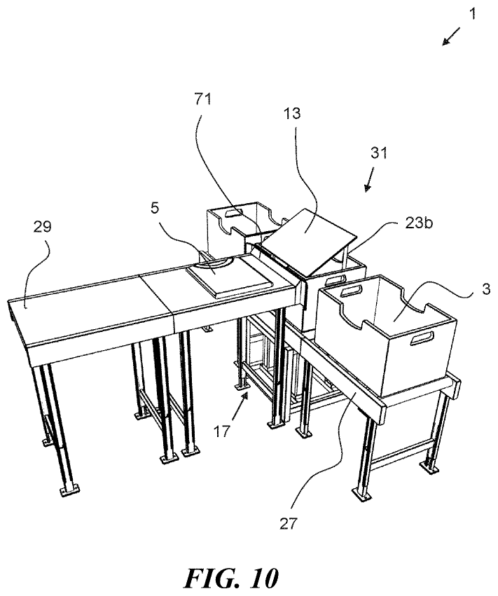

FIG. 10 illustrates a different view of the stock retrieval system of FIG. 8. The stock 5 has been transferred from the base plate 13 onto the stock surface 29. An inclined ledge 71 is provided to connect the base plate 13 in the raised position with the stock surface 29, and provide a smoother transition. The slope of the inclined ledge 71 further assists the stock 5 to slide from the inclined base plate 13 to the stock surface 29. In the illustrated example the inclined ledge 71 is attached to the edge of the stock surface 29 nearest the retrieval position.

In some examples the stock surface 29 may be a stock conveyor. Once the stock 5 has been transferred to the stock conveyor 29, and another stock item 5 on the inclined base plate 13 may be ready to be transferred onto the stock conveyor 29. The advantage of the stock surface 29 being a stock conveyor is that stock 5 that has been transferred from a storage container 3 can be conveyed away from the stock retrieval system 1. This frees up space on the stock conveyor 29 for further stock 5 to be retrieved from a further storage container 3 and transferred onto the stock conveyor. Thus, a continuous flow of storage containers 3 on the container conveyor 27 and retrieved stock 5 on the stock conveyor 29 allows the system to operate continuously.

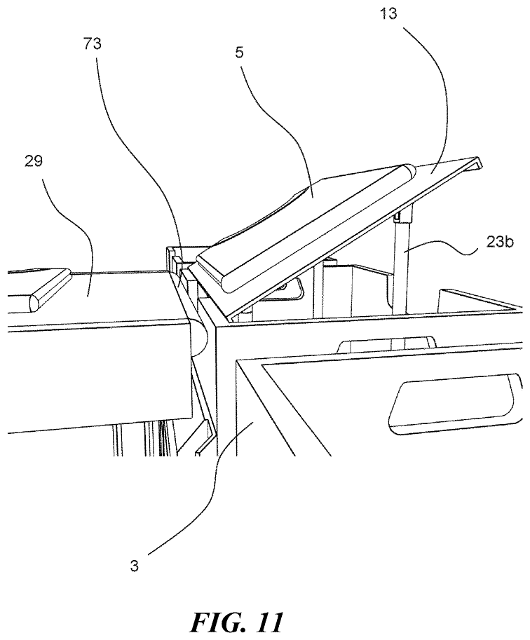

FIG. 11 illustrates a further detail of a stock retrieval system 1 where the transfer means is a tilting mechanism. A roller 73 is provided between the stock surface 29 and the bottom of the inclined base plate 13 when the associated container 3 is in the retrieval position and the base plate 13 in the raised position. The roller 73 further assists the transfer of the stock 5 from the inclined base plate 13 to the stock surface 29, by rotating in a direction away from the base plate so as to help move the stock from the base plate to the stock surface 29. The roller may be a passive roller or the roller may be actively driven. In some examples, more than one roller may be provided. The roller 73 can be used as an alternative to or in combination with the inclined ledge 71 as illustrated in FIG. 10.

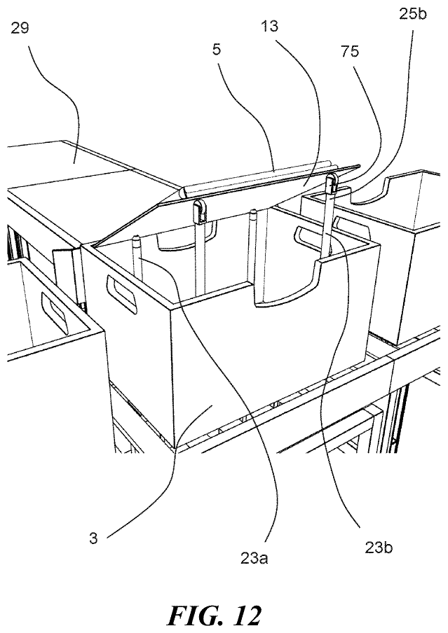

FIG. 12 illustrates a further detail of a stock retrieval system 1 where the transfer means is a tilting mechanism. In this example the upper ends 25b of the second set of supporting rods 23b are fitted with guide wheels 75. As the second set of supporting rods 23b is raised in height, the guide wheels 75 roll along the base plate 13 towards the edge of the base plate 13. The presence of guide wheels makes this motion smoother, and prevents wear that would otherwise be caused by the scraping of the upper ends 25b of the second set of supporting rods 23b against the underside of the base plate 13.

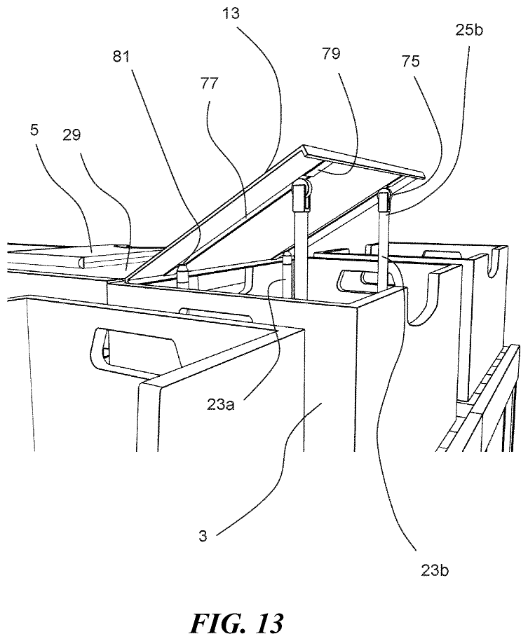

FIG. 13 illustrates a further detail of a stock retrieval system 1 where the transfer means is a tilting mechanism. In this example the underside of the base plate 13 is provided with guide channels 77 for guiding the guide wheels 75. These guide channels 77 ensure that the guide wheels follow a predetermined path between their position when the base plate 13 is in the raised position, and their position when the base plate 13 is in the inclined position. The guide channels 77 are each provided with a guide wheel stop 79, which stops the guide wheel 75 from proceeding further along the guide channel 77 once the base plate 13 has reached the inclined position. This is turn stops the second set of supporting rods 23b from rising any higher. In other words, the guide wheel stop 79 stops the guide wheel 75 at the top of the guide channel 77 when the second set of lifting rods 23b reach the end of their travel/their maximum height. The guide channels 77 are also each provided with a supporting rod stop 81 to stop the first set of supporting rods 23a from proceeding any further along the guide channels 77 once the base plate 13 has reached its inclined position.

In FIG. 13 the base plate 13 is illustrated as having downturned edges or lips on two opposing sides. The purpose of these lips is to ensure that the base plate 13 lies flat and is stable when resting on the bottom wall of the storage container 3 in the lowered position. The guide wheel stops 79 and/or the rod stops 81 may protrude below the bottom surface of the base plate 13, which could otherwise mean that the base plate 13 could be unstable and/or not be level.

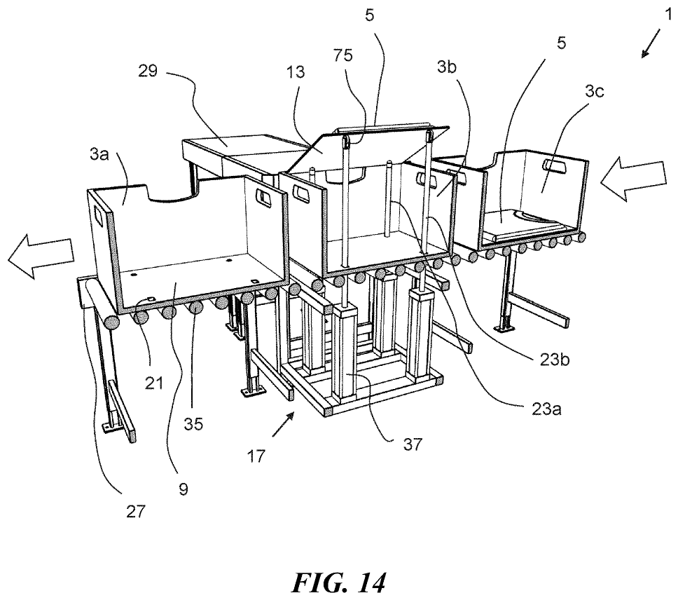

FIG. 14 illustrates a cross sectional view of the stock retrieval system 1 of FIGS. 8 to 13. Three storage containers 3a, 3b, 3c can be seen. The openings 21 in the bottom wall 9 of the storage containers 3 can easily be seen. The supporting rods 23a, 23b can be seen passing through the openings 21 in the bottom wall 9 of the storage container 3b in the retrieval position. The upper ends of the first set of supporting rods 23a engage with the underside of the base plate 13 on the side of the base plate 13 nearest to the stock surface 29. The guide wheels 75 at the upper ends of the second set of supporting rods 23b engage with the underside of the base plate 13 on the side of the base plate 13 farthest from the stock surface 29. The second set of supporting rods 23b are lifted higher than the first set of supporting rods 23a, so that the base plate 13 is in the inclined position.

The direction of movement of the storage containers 3 along the conveyor is indicated by arrows on FIG. 14. The storage container labelled 3a has already had the stock 5 removed. The storage container labelled 3b is currently in the inclined position, ready for the stock 5 to slide from the inclined base plate 13 onto the stock surface 27. The storage container labelled 3c is waiting to move into the retrieval position once the stock 5 has been retrieved from the previous storage container 3b in the line of storage containers 3.

### Pushing Device—Third Embodiment of Transfer Means

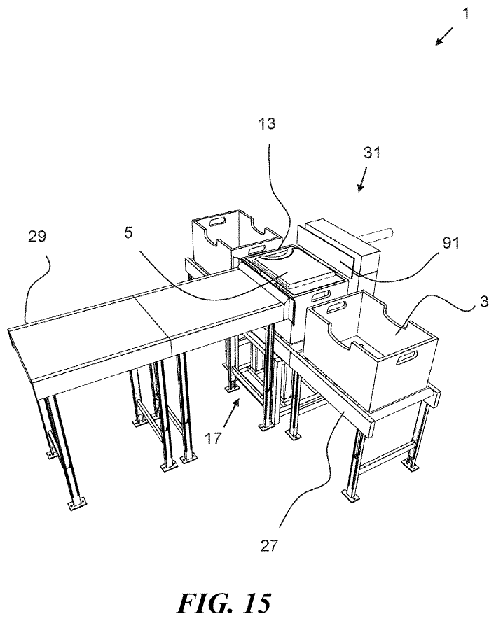

FIG. 15 schematically illustrates another example of a stock retrieval system 1 with transfer means 31. In this example the transfer means 31 comprises a pushing device 91, for pushing the stock 5 from the base plate 13 of the storage container 3 onto the stock surface 29. The pushing device 91 comprises a flat face and a pushing rod.

In use, first the drive mechanism 17 lifts the base plate 13 into the raised position. The pushing device 91 then moves horizontally from a retracted position to a deployed position in order to push the stock 5 from the base plate 13 onto the adjacent stock surface 29. The flat face of the pushing device engages with the side of the stock 5 in order to push the stock 5 along the surface of the base plate 13 and off the base plate 13 onto the stock surface. In the illustrated example there is an inclined ledge 71 between the base plate 13 and the stock surface 29, as described above, in order to facilitate smooth movement of the stock 5 onto the stock surface. In other examples, a roller could be provided as an alternative or in addition to the inclined ledge.

The pushing device 91 can be manually operated, or powered by a linear actuator, an electric motor, a hydraulic system, or any other appropriate mechanism.

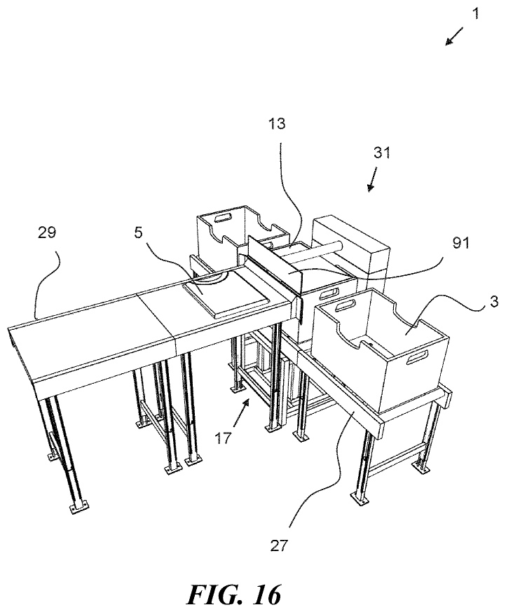

FIG. 15 illustrates the pushing device 91 in a retracted position, i.e. with the flat face adjacent to the side of the stock 5 in the raised position. FIG. 16 illustrates the pushing device 91 in a deployed position, i.e. the pushing device has been moved horizontally over the base plate in order to push the stock 5 off the base plate 13 and onto the stock surface 29.

As with the example of the stock retrieval system where the transfer means is a tilting mechanism, in this illustrated example the entire stock 5 is transferred from a storage container 3. However, in other examples either a single stock item or a stack of stock items can be transferred. In the case where a stack of stock items is transferred, the flat face of the pushing device 91 may be taller, in order to engage with the full height of the stack of stock items.

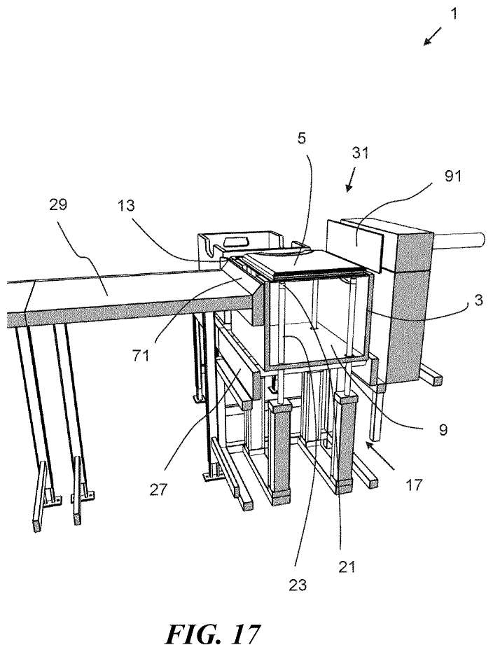

As illustrated in FIG. 17, in this example the drive mechanism 17 comprises supporting rods 23 which protrude through openings 23 in the bottom wall 9 of the storage container 3 in a similar fashion to in the embodiments discussed above.

The pushing device 91 could be used in conjunction with the tilting base plate 13 of the previously described embodiment. For example, the pushing device can be angled such that the pushing device moves in a direction parallel to the base plate when the base plate is in the inclined position.

Supporting Rods with Wheels

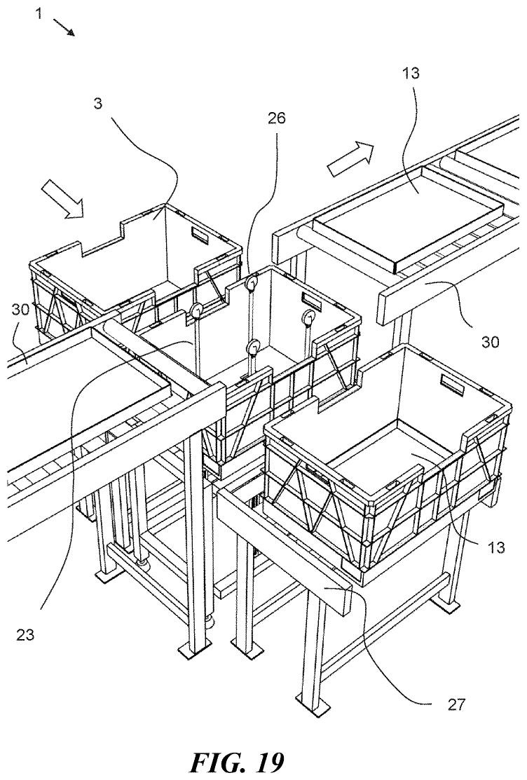

FIG. 19 schematically illustrates another example of the stock retrieval machine 1. Storage containers 3 are conveyed to and from the retrieval position by a container conveyor 27, in the direction indicated by the arrow in the top left of the figure. The containers upstream of the retrieval position (in the top left of the diagram) have no base plate, and the storage containers downstream of the retrieval position (in the bottom right) do have a base plate 13. Underneath the container conveyor 27 is the drive mechanism (not shown), which operates the supporting rods 23. Each supporting rod 23 has a wheel 26 attached to its upper end. The wheels 26 are configured to rotate about an axis parallel to the direction of travel of storage containers 3 along the container conveyor 27.

Although each supporting rod 23 is illustrated with one wheel 26 in the illustrated example, in other examples a supporting rod may have an array of wheels on the same supporting rod. In some examples a subset of the supporting rods may have wheels, with the remaining supporting rods without wheels. In some examples, one or more of the supporting rods may have wheels and the remainder of the rods may have engagement features as described below.

A second conveyor, termed the base plate conveyor 30, is positioned at either side of the retrieval position and aligned in a direction perpendicular to the direction of the container conveyor 27. The base plate conveyor 30 conveys base plates 13 to and from the retrieval position in the direction indicated by the arrow. The wheels 26 thus enable the base plate 13 to move in the direction of the base plate conveyor 30, so that the supporting rods can receive a base plate 13 from the base plate conveyor 30 or transfer a base plate 13 to the base plate conveyor 30.

To put a base plate 13 in a storage container 3, the base plate 13 is transferred from the rollers of the base plate conveyor 30 onto the wheels 26 of the supporting rods 23, and when the base plate 13 is within the footprint of the storage container 3, the supporting rods 23 are lowered in order to place the base plate 13 in the storage container 3. Alternatively a base plate 13 can pass along the base plate conveyor 30, over the wheels 26 on the supporting rods 23, and onto the base plate conveyor 30 on the other side of the retrieval position without being lowered into a storage container 3. This can be useful in cases where the base plates 13 are carrying stock, and the correct stock items need to be placed into the storage containers. The stock retrieval machine 1 can also work in the reverse direction, i.e. to remove a base plate 13 from a storage container 3. In this case the base plate 13 inside the storage container 3 is lifted into the raised position by the supporting rods 23, the base plate 13 is transferred from the wheels 26 of the supporting rods 23 onto the rollers of the base plate conveyor 30, then the base plate 13 is conveyed away by the base plate conveyor 30.

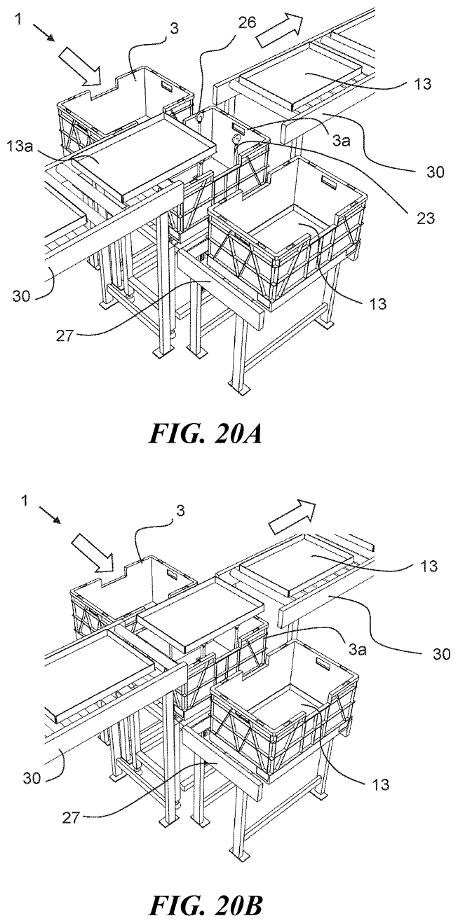

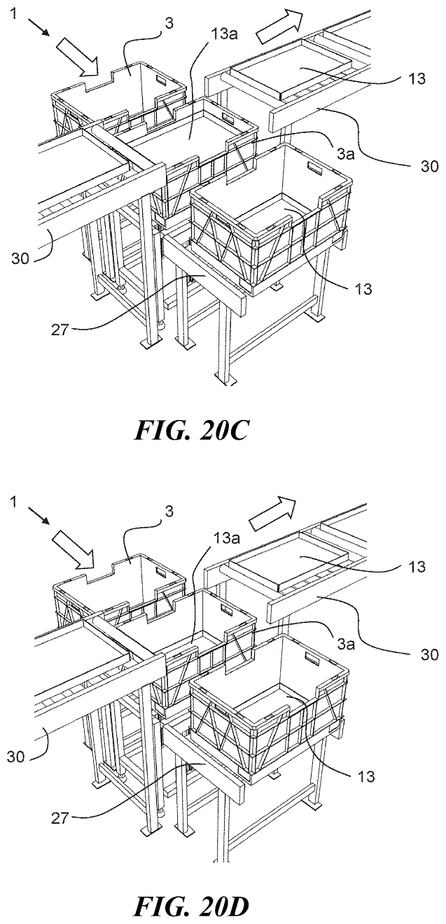

FIGS. 20A-20D schematically illustrate the stock retrieval machine 1 in operation. In FIG. 20A, a particular base plate 13a is being conveyed by the base plate conveyor 30 into the retrieval position. The supporting rods 23 are fully extended, so that the wheels 26 are at the same vertical level as the base plate conveyor 30. The base plate 13a moves smoothly from the rollers of the base plate conveyor 30 to the wheels 26 on the supporting rods 23. In FIG. 20B, the base plate 13a has moved into the retrieval position, and is directly above a particular storage container 3a, at a level above the rim of the storage container 3a, i.e. in the raised position. In FIG. 20C, the supporting rods are retracted by the driving mechanism, while supporting the base plate 13a. The base plate 13a is thus lowered down into the storage container 3a. In FIG. 20D, the supporting rods have been lowered further such that the base plate 13a rests on the bottom wall of the storage container 3a, i.e. the base plate 13a is in the lowered position. Now that the storage container 3a has its base plate 13a inserted, the storage container 3a can be moved away by the container conveyor 27. Another storage container 3 can then be conveyed to the retrieval position, ready for another base plate 13 to be inserted in the same way.

The base plates 13 are illustrated in FIGS. 19 and 20 as trays, with a lip on all sides. In other examples, base plates 13 without a lip may be used. For ease of illustration there is no stock illustrated on the base plates, but in some examples the stock retrieval machine can be used to place trays containing stock into storage containers. FIG. 20 illustrates the operation of putting base plates into storage containers, but the operation can equally well be carried out in reverse, i.e. the stock retrieval machine can be used to remove base plates from storage containers (with or without stock).

The wheels-on supporting-rods mechanism is a means of inserting base plates into storage containers or removing base plates from storage containers. It can be used with empty base plates (as illustrated here) or base plates holding stock. It can be used as an alternative to or in addition to the transfer means discussed above, at the same station or at different stations in a larger system.

### Engagement Features

In some examples the upper ends of one or more of the supporting rods and/or the underside of the base plate may comprise engagement features to engage the upper end of the supporting rod with the underside of the base plate. The purpose of the engagement features is to overcome any snagging or catching of the edges of the base plate on the interior of the side walls of the storage container, and also to ensure good alignment of the base plate within the storage container when in the lowered position. Engagement features are particularly useful if the side walls of the storage containers are not exactly parallel, due to manufacturing variations. The engagement features may be on the upper ends of the rods, the underside of the base plate, or both.

A high friction surface can be used, for example a rubber pad or O-ring. An electroadhesive surface (e.g. a pad) may be used, in which current is applied to conductive electrodes to generate an electric field. The electric field creates opposite charges on the surface touched by the pad, causing electrostatic adhesion between the electrodes and the induced electric charges on the contacting surface. Magnetic pads can be used, either electromagnetic or permanent magnets. The upper ends of the supporting rods may be tapered, and engage with corresponding recesses on the underside of the base plate. Alternatively, a recess in the upper end may engage with a protrusion on the underside of the base plate. In the example illustrated in FIGS. 19 and 20 where the supporting rods comprise wheels, grooves or tracks could be provided on the underside of the base plate as engagement features, with deeper portions or recesses to locate the wheels at the appropriate position along the track. These are examples only, and any suitable engagement feature may be used.

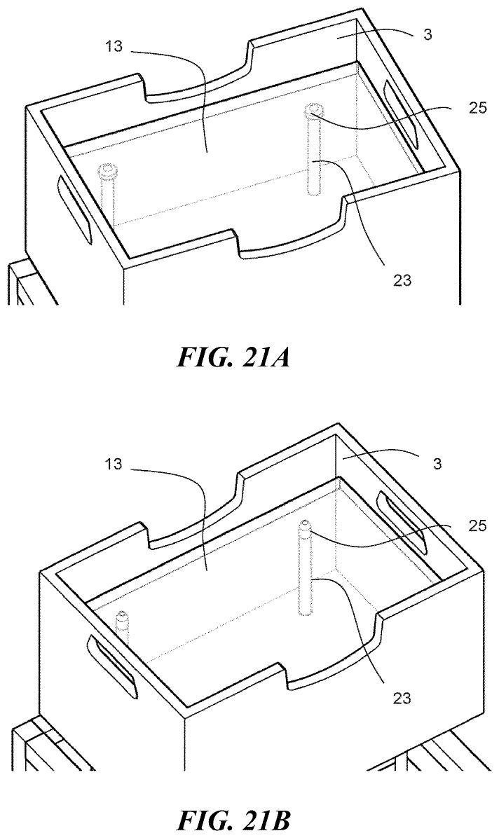

FIG. 21 illustrates two different examples of engagement features. FIG. 21A illustrates pads at the upper ends 25 of the supporting rods 23. The base plate 13 is illustrated as transparent for ease of visualization so that the upper ends of the supporting rods can clearly be seen. Pads (for example, frictional, adhesive, or magnetic) provide a greater surface area, which may assist with engagement.

FIG. 21B illustrates another example, in which the upper ends 25 of the supporting rods 23 are tapered.

### Sealing

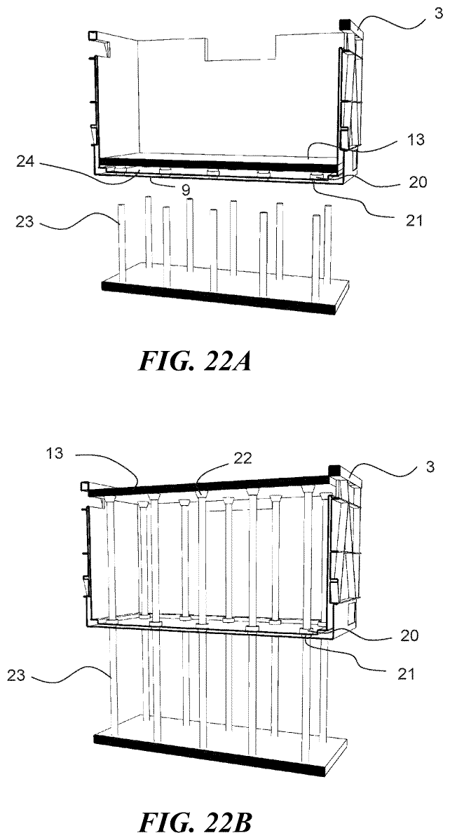

In some examples, the stock to be handled by the stock retrieval machine may include liquids. For some product types, e.g. hazardous liquids, breakable products that contain liquids, or mixed product types e.g. grocery where cleaning fluids and food can be packed in the same containers, it is particularly important to contain any spills. FIG. 22 shows an example of a storage container 3, base plate 13, and supporting rods 23 for use in such cases. The openings 21 in the bottom wall of the storage container 3 are surrounded with seals 20 to prevent liquid leaking through the openings 21. The edge of the base plate may also be surrounded by a seal.

FIG. 22A shows the base plate 13 in the lowered position. It can be seen that there is a space 24 between the base plate and the bottom wall 9. This space can be used as a small reservoir for collecting and containing any spilled liquids. In some cases a moisture sensor can be provided within the space 24 to detect when a spill has occurred. FIG. 22B shows the base plate 13 in the raised position. The underside of the base plate has engagement features 22, in this example self-locating tapered feet. The tapered feet sit within the seals 20 when the base plate 13 is in the lowered position, thus providing the dual purpose of sealing the openings 21 (thus enabling the supporting rods 23 to be fully retracted and removed) and acting as spacers to provide the space 24 between the base plate 13 and the bottom wall 9 of the storage container 3.

### Alignment Features

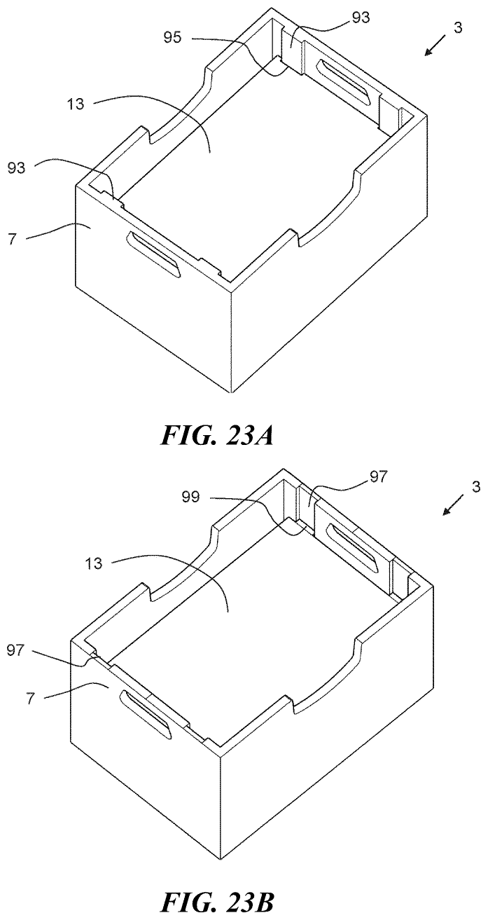

FIG. 23 illustrates examples of alignment features to ensure a smooth motion of the base plate 13 as it moves vertically inside the storage container 3 between the raised position and the lowered position. The edge of the base plate 13 slides along the inside of the side walls 7.

In FIG. 23A, the inside of the two shorter side walls 7 of the storage container are provided with vertical ribs 93 extending from the bottom wall to the rim of the storage container 3. The base plate 13 comprises corresponding recesses 95 on the two short sides of the base plate 13. The vertical ribs 93 and the recess 95 co-operate to guide the vertical movement of the base plate between the lowered position and the raised position.

In FIG. 23B, the inside of the two shorter side walls 7 of the storage container 3 are provided with vertical grooves 97 extending from the bottom wall to the rim of the storage container 3. The base plate 13 comprises corresponding protrusions 97 on the two short sides of the base plate 13. The vertical grooves 97 and the protrusions 99 co-operate to guide the vertical movement of the base plate between the lowered position and the raised position.

In both of these examples, ribs/recesses or grooves/protrusions are provided on two opposing sides of the storage container. Other arrangements are also possible; alignment features can be provided on one side, multiple sides, or all sides of the storage container, and/or alignment features can be provided on one corner, multiple corners, or all corners of the storage container. Combinations of different alignment features can be used.

### Other Variants

The specific embodiments described herein are non-limiting examples of how the stock retrieval system can be implemented, and it will be evident to the skilled person that variations are possible. For example, the transfer means could be provided by a human worker, or by any other suitable mechanism or combination of mechanisms that are able to fulfill the function of retrieving one or more stock items from a storage container, once the base plate of the storage container is in the raised position so that at least a portion of the stock is accessible from the side. In examples where the transfer means is a robot arm, other kinds of end effectors can be used in place of the grabber device, for example a suction cup or a magnet.

In some examples, more than one different kind of transfer means can be provided in the same stock retrieval system. For example, a stock retrieval system may be provided with a robot arm, a tilting base plate, and/or a pushing device. Different transfer means may be appropriate in different situations, for example a robot arm with grabber device enables the transfer of part of the stock while leaving some stock in the storage container, and a tilting base plate and/or a pushing device is more appropriate for transferring the entire stock on the base plate. The provision of different kinds of transfer means provides more flexibility, and allows the same stock retrieval system to handle different numbers and types of stock item.

Similarly, alternative drive mechanisms can be used. In other examples the drive mechanism can be contained within the storage container, for example a hydraulic or scissor-lift or rack-and-pinion mechanism can be located within the storage container in a space between the base plate and the bottom wall of the storage container and used to raise the level of the base plate from the lowered position to the raised position.

In some examples the distance between the lowered position and the raised position of the base plate may be a single fixed distance, and in other examples this distance may be variable. A variable distance permits the portion of the stock that protrudes above the rim of the storage container to be varied, which allows different quantities of stock to be retrieved.

In cases where the drive mechanism is external to the storage container, the base plate can be lifted with respect to the storage container, and/or the storage container can be lowered with respect to the base plate, as illustrated schematically in FIG. 2. This principle can also be applied to other kinds of drive mechanism.

Arrangements of container conveying means and stock conveying means in the stock retrieval system can also vary. Although the specific examples described use a container conveyor and a stock output surface or stock conveyor, in other examples different container conveying means can be used in place of the container conveyor, and different stock conveying means can be used instead of the stock surface or stock conveyor. For example, the container conveying means and/or the stock conveying means can be a conveyor, a robot arm, one or more vehicles, or any other suitable means that can transport a storage container or stock. For example, a stock retrieval system may be provided with zero, one, or more than one container conveying means, of the same kind or of different kinds, and zero, one, or more than one stock surface or stock conveying means, of the same kind or of different kinds. An arrangement with multiple container conveying means has the advantage that storage containers can be moved between the stock retrieval system and other parts of a larger storage system. Similarly, an arrangement with multiple stock conveying means has the advantage that stock can be moved to or from other parts of a larger storage system. In some examples, the stock retrieval system may have one or more stock surfaces and one or more stock conveying means.

In some examples, more than one transfer means can be used in the same stock retrieval system. For example, different kinds of transfer means may be appropriate for different kinds or different sizes of stock, or different kinds or different sizes of storage container. In other examples, one transfer means can be shared between multiple adjacent stock retrieval systems. For example, in cases where the transfer means is a robot arm, the robot arm may be positioned between two stock retrieval systems such that both stock retrieval systems are within the reach of the robot arm.

### Method of Retrieving Stock

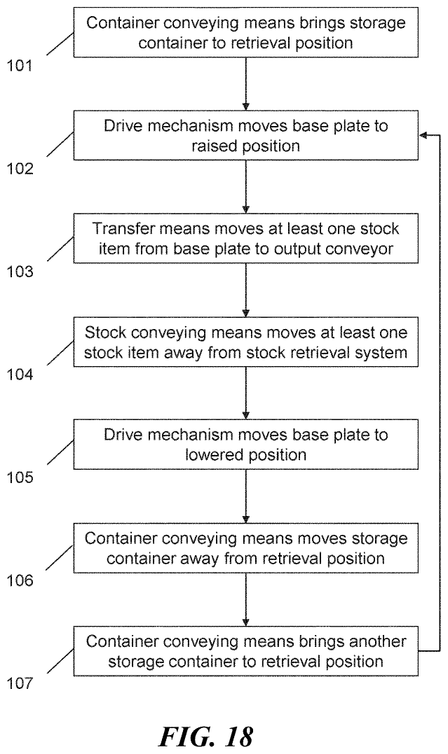

FIG. 18 is a flowchart schematically illustrating a method of stock retrieval, using the stock retrieval system as described above. In a step 101, the container conveying means brings a storage container containing stock to the retrieval position, ready for the stock to be retrieved. In a step 102, the drive mechanism moves the base plate of the storage container from the lowered position to the raised position. In the raised position, at least a portion of the stock in the storage container protrudes above the rim of the storage container, so is accessible from the side. In a step 103, the transfer means retrieves at least one stock item from the portion of the stock above the level of the rim, and places the at least one stock item on the stock conveying means. As discussed above, the transfer means can take many different forms. In a step 104, the stock conveying means moves the at least one stock item that has just been retrieved from the storage container away from the stock retrieval system, for example to a picking or packing station in another part of the storage facility. In a step 105, the drive mechanism moves the base plate back to the lowered position. In a step 106, the container conveying means moves the storage container away from the retrieval position, in order to make space for another storage container. If the storage container still contains stock (i.e. in the case where not all of the stock was retrieved by the transfer means in step 103), the storage container can be conveyed back into the storage system. If the storage container is empty, the storage container can be conveyed to a different part of the storage system for checking/cleaning or to be reused for new stock coming into the storage system. In a step 107, the container conveying means brings another storage container containing stock items to be retrieved to the retrieval position, ready for the process to start again with the new storage container. The arrow on FIG. 18 from step 107 back to step 102 indicates that the method of stock retrieval is repeated for the new storage container. Stock retrieval from storage containers can be a continuous process, with new storage containers being brought into the stock retrieval system by the container conveying means, and storage containers being removed from the stock retrieval system by the stock conveying means after the necessary stock has been retrieved.

This method as described is indicative only, and not all steps may be relevant for all stock retrieval systems. For example, some stock retrieval systems may not be provided with a container conveying means and/or a stock conveying means. The method may also be applied with the steps in reverse order to enter stock into a storage and retrieval system.

### Further Features

The disclosure can also be defined by the following numbered clauses:
1. A stock retrieval system comprising:
i) a storage container for containing stock;
ii) a base plate configured to support stock and to be housed within the storage container, the base plate being vertically movable relative to a bottom of the storage container;
iii) a drive mechanism configured to move the base plate relative to the bottom of the storage container from a lowered position, in which the base plate is at a level below a top of at least one side wall of the storage container, to a raised position, in which the base plate is substantially at or above the same vertical level as the top of at least one side wall of the storage container.
2. The stock retrieval system of clause 1, wherein the storage container comprises at least one side wall optionally having a rim at the upper edge of the at least one side wall.
3. The stock retrieval system of clause 1 or clause 2, wherein the storage container comprises a bottom wall.
4. The stock retrieval system of clause 3, wherein the base plate is vertically movable relative to the bottom wall of the storage container.
5. The stock retrieval system of clause 3 or clause 4 where dependent on clause 2, wherein the at least one side wall and the bottom wall define a box-like structure.
6. The stock retrieval system of any preceding clause, wherein the base plate comprises at least one free edge.
7. The stock retrieval system of clause 6 where dependent on clause 2, wherein the at least one free edge is adjacent to the at least one side wall when the base plate is housed within the storage container.
8. The stock retrieval system of any preceding clause, further comprising a control system configured to control the drive mechanism to move the base plate between the raised position and the lowered position.
9. The stock retrieval system of clause 8, wherein the control system is further configured to control the drive mechanism to move the base plate from the lowered position to at least one intermediate position at a vertical level between the lowered position and the raised position.
10. The stock retrieval system of any preceding clause, wherein the drive mechanism comprises at least one supporting rod comprising an upper end configured to engage with the underside of the base plate, and optionally wherein, when dependent on clause 3, the bottom wall comprises at least one opening, and the at least one supporting road is configured to protrude through the at least one opening.
11. The stock retrieval system of clause 10, wherein the drive mechanism is configured to move the at least one supporting rod vertically upwards to lift the base plate within the storage container from the lowered position to the raised position.
12. The stock retrieval system of clause 10, wherein the drive mechanism is configured to move the storage container vertically downwards relative to the base plate.
13. The stock retrieval system of any of clauses 1 to 9, wherein the drive mechanism is contained within the storage container.
14. The stock retrieval system of any preceding clause, further comprising transfer means configured to remove at least one item of stock from the base plate, when the base plate is in the raised position.
15. The stock retrieval system of clause 14, wherein the transfer means comprises a robot arm with an end effector comprising one or more horizontal lifting plates moveable between a closed position in which the one or more horizontal lifting plates support the at least one item of stock from below and an open position in which the one or more horizontal lifting plates are disengaged with the at least one item of stock.
16. The stock retrieval system of clause 14, wherein the transfer means comprises a tilting mechanism configured to tilt the base plate at the raised position to an inclined position to allow the at least one item of stock to be removed by sliding off the base plate.
17. The stock retrieval system of clause 16 when dependent on clause 14, wherein the drive mechanism comprises a plurality of supporting rods and the tilting mechanism is configured to move a first set of the plurality of supporting rods relative to a second set of the plurality of supporting rods such that the upper ends of the second set of supporting rods are at a higher vertical level than the upper ends of the first set of supporting rods.
18. The stock retrieval system of clause 14, wherein the transfer means comprises a pushing device configured to move in a direction parallel to the base plate so as to remove the at least one item of stock from the storage container by pushing the at least one item of stock off the base plate.
19. A method of retrieving stock using the stock retrieval system of any preceding clause, wherein the storage container comprises one or more items of stock on the base plate, the method comprising the steps of:
i) moving the base plate from the lowered position to the raised position or an intermediate position between the lowered position and the raised position using the drive mechanism such that at least one item of stock on the base plate is at a level vertically above the top of the at least one side wall of the storage container;
ii) removing the at least one item of stock from the base plate.
20. The method of clause 19 wherein the stock retrieval system further comprises an output conveyor, the method further comprising the steps of:
iii) transferring the at least one item of stock onto the output conveyor; and
iv) transporting the at least one stock item away from the stock retrieval system using the output conveyor.
21. The method of clause 20 or 21 wherein the stock retrieval system comprises an input conveyor configured to move the storage container into a retrieval position, the method further comprising the steps of:
before step i), moving the storage container to the retrieval position using the input conveyor;
after step ii), moving the base plate to the lowered position using the drive mechanism, moving the storage container away from the retrieval position using the input conveyor, and moving another storage container into the retrieval position using the input conveyor.

1. A stock retrieval system comprising:
i) a storage container for containing stock;
ii) a base plate configured to support stock and to be housed within the storage container, the base plate being vertically movable relative to a bottom of the storage container; and
iii) a drive mechanism configured to move the base plate relative to the bottom of the storage container from a lowered position, in which the base plate is at a level below a top of at least one side wall of the storage container, to a raised position, in which the base plate is substantially at or above the same vertical level as the top of the at least one side wall of the storage container,
wherein the drive mechanism comprises at least one supporting rod comprising an upper end configured to engage with the underside of the base plate.

2. The stock retrieval system of claim 1, wherein the storage container comprises a bottom wall comprising at least one opening, and the at least one supporting rod is configured to protrude through the at least one opening.

3. The stock retrieval system of claim 1, wherein the base plate comprises at least one side wall substantially lower in height than the at least one side wall of the storage container.

4. The stock retrieval system of claim 1, further comprising a control system configured to control the drive mechanism to move the base plate between the raised position and the lowered position.

5. The stock retrieval system of claim 4, wherein the control system is further configured to control the drive mechanism to move the base plate from the lowered position to at least one intermediate position at a vertical level between the lowered position and the raised position.

6. The stock retrieval system of claim 1, wherein the drive mechanism is configured to move the at least one supporting rod vertically upwards to lift the base plate within the storage container from the lowered position to the raised position.

7. The stock retrieval system of claim 1, wherein the drive mechanism is configured to move the storage container vertically downwards relative to the base plate.

8. The stock retrieval system of claim 1, further comprising transfer means configured to remove at least one item of stock from the base plate, when the base plate is in the raised position.

9. The stock retrieval system of claim 8, wherein the transfer means comprises a robot arm with an end effector comprising one or more horizontal lifting plates moveable between a closed position in which the one or more horizontal lifting plates support the at least one item of stock from below and an open position in which the one or more horizontal lifting plates are disengaged with the at least one item of stock.

10. The stock retrieval system of claim 8, wherein the transfer means comprises a tilting mechanism configured to tilt the base plate at the raised position to an inclined position to allow the at least one item of stock to be removed by sliding off the base plate.

11. The stock retrieval system of claim 10, wherein the at least one supporting rod comprises a plurality of supporting rods and the tilting mechanism is configured to move a first set of the plurality of supporting rods relative to a second set of the plurality of supporting rods such that the upper ends of the second set of supporting rods are at a higher vertical level than the upper ends of the first set of supporting rods.

12. The stock retrieval system of claim 8, wherein the transfer means comprises a pushing device configured to move in a direction parallel to the base plate so as to remove the at least one item of stock from the storage container by pushing the at least one item of stock off the base plate.

13. The stock retrieval system of claim 1, wherein the upper end of one or more of the at least one supporting rod and/or the underside of the base plate comprises an engagement feature configured to engage the upper end with the underside of the base plate.

14. The stock retrieval system of claim 13, wherein the engagement feature comprises one of a high friction surface, an electroadhesive surface, an electromagnetic pad, and a permanent magnetic pad.

15. The stock retrieval system of claim 2, further comprising a seal surrounding each of the at least one opening in the bottom wall of the storage container and/or a seal surrounding the edge of the base plate and/or a space between the base plate and the bottom wall, optionally wherein the space comprises a moisture sensor.

16. The stock retrieval system of claim 1, wherein the inside of the at least one side wall of the storage container comprises a vertical rib and the base plate comprises a corresponding recess, such that the vertical rib and the recess co-operate to guide the vertical movement of the base plate between the lowered position and the raised position.

17. The stock retrieval system of claim 1, wherein the inside of the at least one side wall of the storage container comprises a vertical groove and the base plate comprises a corresponding protrusion, such that the vertical groove and the protrusion co-operate to guide the vertical movement of the base plate between the lowered position and the raised position.

18. The stock retrieval system of claim 1, wherein the upper end of one or more of the at least one supporting rod comprises a wheel to facilitate movement of the base plate in order to insert/remove the base plate into/from the container when the base plate is in the raised position.

19. The stock retrieval system of claim 18, further comprising a container conveying means configured to move the storage container in a first direction into a retrieval position in which the base plate can be inserted into or removed from the container, and a base plate conveying means configured to convey a base plate to or from the retrieval position in a second direction, wherein the second direction is perpendicular to the first direction.

20. A method of retrieving stock using the stock retrieval system of claim 1, wherein the storage container comprises one or more items of stock on the base plate, the method comprising the steps of:
i) moving the base plate from the lowered position to the raised position or an intermediate position between the lowered position and the raised position using the drive mechanism such that at least one item of stock on the base plate is at a level vertically above the top of the at least one side wall of the storage container; and
ii) removing the at least one item of stock from the base plate.

21. The method of claim 20 wherein the stock retrieval system further comprises a stock conveying means, the method further comprising the steps of:
iii) transferring the at least one item of stock onto the stock conveying means; and
iv) transporting the at least one stock item away from the stock retrieval system using the stock conveying means.

22. The method of claim 20 wherein the stock retrieval system comprises a container conveying means configured to move the storage container into a retrieval position, the method further comprising the steps of:
before step i), moving the storage container to the retrieval position using the container conveying means; after step ii), moving the base plate to the lowered position using the drive mechanism, moving the storage container away from the retrieval position using the container conveying means, and moving another storage container into the retrieval position using the container conveying means.

23. A method of combining a base plate with a storage container using the stock retrieval system as defined in claim 19, the method comprising the steps of:
i) moving the storage container into the retrieval position using the container conveying means;
ii) raising the supporting rods;
iii) moving the base plate from the base plate conveying means to the raised position on top of the at least one supporting rod;
iv) lowering the base plate from the raised position to the lowered position inside the storage container; and
v) removing the storage container and base plate from the retrieval position using the container conveying means.

24. A method of separating a base plate from a storage container using the stock retrieval system as defined in claim 19, the method comprising the steps of:
i) moving the storage container and base plate into the retrieval position using the container conveying means;
ii) raising the base plate into the raised position;
iii) moving the base plate from the raised position to the base plate conveying means;
iv) lowering the at least one supporting rod; and
v) removing the storage container from the retrieval position using the container conveying means.
